(19) United States
(12) Patent Application Publication
(10) Pub. No.: US 2006/0069570 A1
(43) Pub. Date: Mar. 30, 2006

(54) SYSTEM AND METHOD FOR DEFINING AND EXECUTING DISTRIBUTED MULTI-CHANNEL SELF-SERVICE APPLICATIONS

(75) Inventors: Dana H. Allison, Lima, NY (US); Anthony Solpietro, Rochester, NY (US)

Correspondence Address: BLACKWELL SANDERS PEPER MARTIN LLP, 4801 Main Street, Suite 1000, KANSAS CITY, MO, 64112, US

(73) Assignee: RIGHTNOW TECHNOLOGIES, INC., Bozeman, MT (US)

(21) Appl. No.: 11/162,417

(22) Filed: Sep. 9, 2005

Related U.S. Application Data
(60) Provisional application No. 60/609,071, filed on Sep. 10, 2004.

(51) Int. Cl. G10L 21/00

(52) U.S. Cl. 704/270

(57) ABSTRACT

A system and method are provided for defining and executing distributed multi-channel self-service communication systems. A voice system is provided that will assist a user of the system to query the system and receive feedback from the system which can lead to additional queries of the system in order for the user to use a phone-in system for informational purposes. A query is provided from a user in the form of spoken word. The spoken word is converted into a format for searching a knowledge database. The knowledge database is searched for at least one answer object and when found is presented to the user.

### CROSS-REFERENCE TO RELATED APPLICATIONS

This application is a Non-Provisional application based on Provisional Application Ser. No. 60/609,071, Filed Sep. 10, 2004 for a SYSTEM AND METHOD FOR DEFINING AND EXECUTING DISTRIBUTED MULTI-CHANNEL SELF-SERVICE APPLICATIONS

The entire disclosure of the just referenced provisional patent application is incorporated herein by reference.

### TECHNICAL AREA OF THE INVENTION

The present invention relates generally to a method of assistance and apparatus for providing self directed assistance, and more particularly, to such a method and apparatus for defining and executing distributed multi-channel self service applications.

### BACKGROUND

In an increasingly competitive marketplace, businesses are continually searching for methods of reducing expenses while maintaining, or possibly increasing the level of services they provide their customers. Self service applications are often employed to fulfill this objective. Businesses that already provide some degree of customer support could use self service applications to expand their service, while fledgling businesses may consider providing customer support when it was initially not feasible.

Currently, automated self-service over the telephone entails using interactive voice response (IVR) systems to dialog with customers by playing prompts and getting responses using DTMF touch-tones and/or some form of speech recognition. Customized implementations are often necessary for most enterprises to address the complexity and breadth of services required. Currently, vendors offer proprietary tools to enable businesses to create their own custom applications and/or offer professional services to develop customized solutions.

While various other forms of self-service automation, such as touch-tone systems, are known, speech recognition is the option that most customers, prefer. Additionally, because it requires no more than speaking into a phone, this option is accessible by most potential consumers.

Many automated self-service systems utilize some type of a speech recognition system. Speech recognition systems serve to reduce costs and furnish competitive advantages for a wide variety of businesses, ranging from the pharmaceutical and healthcare organizations to the financial service industry. Generally, most businesses that utilize speech recognition systems find the pay back on investment to be less than a year.

In operation, speech recognizing systems receive a spoken word, or set of spoken words uttered by a speaker, and return a list of possible search recognition results. While the task may at first appear to be relatively simple, it is an extremely complex procedure, requiring computer systems having extensive processing power and memory capability.

To better understand this process, a general background on grammars and phonemes specific to the art of speech recognition is provided. A speech recognition system contains a database with numerous graphs that serve to identify the vast range of sounds uttered by humans. An utterance is generally characterized by a lengthy string of sounds. Once the sound is identified, a feature number, representative of that particular sound is assigned thereto. The next step entails matching a phoneme to the string of feature numbers. This step is extremely difficult for various reasons including, but not limited to, variations in individual user's diction, background noise, and general pronunciation conventions attributed to the particular language. A speech recognition system addresses these complexities by various means including; assigning probabilities to each feature in the string, as compared to a plurality of phonemes, using mathematical techniques such as “Hidden Markov Models” (HMMs) that assist search engines in determining when one phoneme ends and the next begins; and creating “tri-phones” which are phonemes in the context of the position of phonemes around them. Upon completion of the aforementioned steps, the speech recognition system renders its results, wherein a confidence score is applied to each of the provided results.

The speech recognition system then utilizes these results to decide the most suitable phrase, or course of action. Many times the confidence scores of the results ascertained by the system are fairly close utilizing an additional means for prioritizing one particular result before another. In such instances grammar designers refine the search by creating, what is referred to in the art as, grammars.

The grammars serve to restrict the phrases that the speech recognition system may consider in determining the user's spoken words. Additionally, grammars also include weighting factors that provide a means for determining which phrase is more likely based on a specific application.

User interfaces having speech recognition capabilities are known in the art. One such system is disclosed in U.S. Pat. No. 6,434,524 titled Object Interactive User Interface Using Speech Recognition and Natural Language Processing. The reference discloses a system and method wherein utterances are used to establish interactions with objects. The system encompasses both speech processing and natural language processing. In operation, a speech processor searches a first grammar file for a matching phrase for the utterance. If the matching phrase is not found in the first grammar file then a second grammar file is searched. The natural language processor searches a database for a matching entry assigned to the matching phrase. Upon finding the matching entry, an application interface serves to perform the action that is associated with said entry. The speech recognition and natural language processing efficiency are optimized by utilizing user voice profiles, that can be updated for the individual users.

While having individual user voice profiles enables the system to enhance the reliability of speech recognition processing, such an approach is not practical for larger systems serving to provide a platform for a greater number of users. Furthermore, multiple user systems may not have sufficient access tiers to allow training of multiple users. Generally, the storage capabilities and system maintenance necessary to sustain such an operation is too costly and time consuming to be practical.

Internet based, searchable knowledge bases are known to accept text keywords from users to thereby search for items stored in the knowledge bases. Methods exist for returning results dynamically influenced by accumulated search activity of various channels and sources, thereby allowing the results of the search to adapt to changes in the products and services being offered, and the resulting questions they generate from file customer base. For example, a list of frequently asked questions may be returned from the query whereby the most likely desired response (or most requested) is listed first.

Furthermore, providing self-service on the Internet typically involves building web sites containing product information. Innovations using specialized databases, or knowledge bases that can be configured to address specific enterprise products and services support through straightforward Web interfaces are known. Generally, web based self-service systems are normalized across a broad enterprise domain using a common model based on frequently asked questions. Customers who have accessed one company's knowledge base are typically very comfortable using another company's knowledge base even though it has completely different offerings of products and services. While knowledge bases are somewhat flexible as a result of configurability and powerful artificial intelligence based search strategies, they are targeted to web access, providing only HTML output to browsers.

One particular searchable database is disclosed in U.S. Pat. No. 6,415,281. The patent discloses a system and method for arranging records in search result in response to a data inquiry of a database. The results of the search will be arranged in an order based on various factors such as the destination of the search results, the preferred status of certain records over other records, a marketing determination with respect to the records, a frequency determination with respect to the number of times that a record or records may have already been provided in response to data inquiries, a weighting factor determination or a combination of one or more of these factors. In response to the determination of the order of the records in the search results, the records then are arranged into ordered records based on the determination. This order may be an alphabetical order, a preferred order based on the preferred status of certain records over other records, a least frequent first order, a highest weighting factor first order, or a combination of these orders. The search results with the records arranged into ordered records are then provided in response to the data inquiry.

While the aforementioned disclosure discusses a wide variety of factors used to determine the order in which search results are to be presented, there is high degree of certainty that the data inquiry received by the database is an accurate representation of the word or phrase as intended by the user. Because of the complexities surrounding speech recognition, as outlined above, the aforementioned degree of certainty on confidence in the word or phrase entered by the user is considerably lower, therefore, the criteria outlined in flue disclosure above would not be adequate for optimizing the matches for a voice/speech searchable database.

Furthermore, with the numerous channels presently available for searching databases, including, but not limited to, telephone, wireless phone, telephone with a display or device such as a PDA or a web browser. Presently dedicated systems are needed to support each of the aforementioned channels when searching knowledge databases.

Therefore, what is needed in the art is an apparatus and method for accessing a knowledge database that is accessible by a wide variety of communication channels.

Furthermore, what is needed in the art is an apparatus and method for accessing a knowledge database that serves to expand the potential user base while minimizing the costs associated with providing and maintaining redundant equipment.

Furthermore still, what is needed in the art is an apparatus and method for accessing a knowledge database that provides a simplified user interface and serves to target the correct response to the user's query.

### SUMMARY OF THE INVENTION

The present invention provides a method and apparatus that serves to enable an enterprise to expand its customer service capabilities by allowing customers/users to query a knowledge database. The system of the present invention provides responses from a knowledge base search responsive to the customer's queries. The responses, or answer objects derived from the invention may be presented to the user in various forms including but not limited to, text, a VoiceXML application, or an XML document. The form presented to the customer will be commensurate with the apparatus by which the customer has interfaced the system.

The system interacts with the customer to retrieve the most appropriate answer object(s) from the knowledge base. The answer object and the invention interact with the caller in a format suitable for the access channel being used by the customer, (e.g. the telephone). Answers become enterprise-defined extensions of the self-service application accessed and managed by the invention. The answer object can be leveraged to further explore the caller's question by soliciting more information to arrive at the targeted answer. This simplifies the user interface by collecting only the information necessary from the user for a given query. Additional information would be solicited only if an answer object required it.

An advantage of the present invention is that it provides an apparatus and method for accessing a knowledge database that is accessible by a wide variety of communication channels, including a telephone, thereby expanding the potential user base while minimizing the costs associated with providing and maintaining redundant equipment.

Another advantage of the present invention is that it provides a simplified user interface, that serves to target the desired response to the user's query.

### BRIEF DESCRIPTION OF THE DRAWINGS

The above-mentioned and other features and advantages of this invention, and the manner of attaining them, will become apparent and be more completely understood by reference to the following description of one embodiment of the invention when read in conjunction with the accompanying drawings, wherein:

FIG. 1 is a representation of a multi-tiered interactive voice recognition platform utilized in the present invention; and

FIG. 2 is a high level flow diagram of a sample process of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION

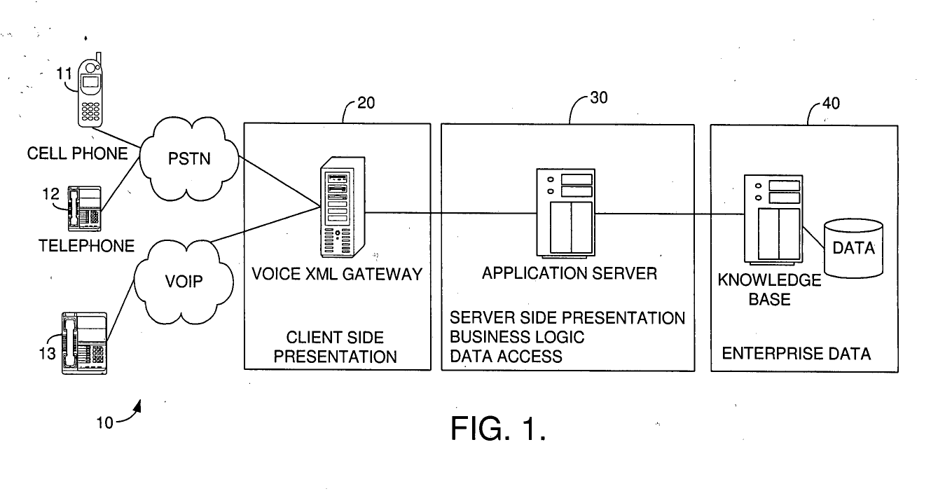

Referring to the drawings, and particularly to FIG. 1, a general overview of a system for searching a knowledge database is shown. More particularly, the system may represent the multi-tiered interactive voice recognition platform, similar to that utilized in the present invention. The system was designed to operate on, and be compatible with, standard hardware and software platforms utilizing web based standards and protocols.

Generally, a caller may query the system via an input communication device 10 such as, for example, a cell phone 11 or a standard telephone 12. The verbal commands issued by caller may be transmitted to the system via either a PSTN (Public switched telephone network), VoIP device 13 (voice over internet protocol), or any suitable means. Such devices also include PDA's, phones with displays and web browsers. These verbal commands are received in the system by the VoiceXML gateway 20. VoiceXML serves multiple voice applications, including speech recognition. The VoiceXML interpreter, operates in a similar manner to a web browser; in that it serves to issue HTTP (Hypertext Transfer Protocol) requests responsive to its interpretation of the speech commands received.

The next stage of the platform, hereby referred to as the Application Server 30 stage, generally includes three segments or tiers, namely the Server Side Presentation Segment, the Business Logic Segment, and the Data Access Segment. The server side presentation segment utilizes Java Server Pages (JSP) and Java Servlet technology to dynamically generate VoiceXML documents in response to the HTTP requests from the VoiceXML Gateway 20. JAVA classes are used to implement the specified business logic. Furthermore the Business Logic Segment or tier serves as an intermediary with the Data Access Segment, wherein the knowledge base is accessed, and the Server Side Presentation segment wherein dialog with the user is received and transmitted. Finally the Data (knowledge) Base Segment 40 communicates with the aforementioned data access tier using standard database technology and protocols, such as, for example, JDBC and XML. The method of the present invention can be used to optimize voice recognition when utilized in systems such as for example the system defined above, however the method of the present invention is capable of being utilized on all voice recognition systems, wherein searches are performed in knowledge databases.

In operation, speech recognition systems analyze speech samples, and generate a list of possible words or phrases that the speaker may have intended. A user calls or connects to a speech recognition system to request assistance. Upon connection, the user will be prompted to either state a keyword of his choosing or to select from a number of keywords offered by the system. The user's spoken keyword(s) are then transformed via a platform, similar to VoiceXML segment outlined above, into a form or keyword that is recognizable to a database, and a list of keywords is generated. The generated list of words is commonly referred to as the “n-th best” list. Furthermore, for each of the results returned on the “n-th best” list, a confidence score is assigned, wherein a number of factors specified in the grammars, or post processing play a part in determining the order of the list. The method of the present invention is capable of optimizing the order of the n-th best list.

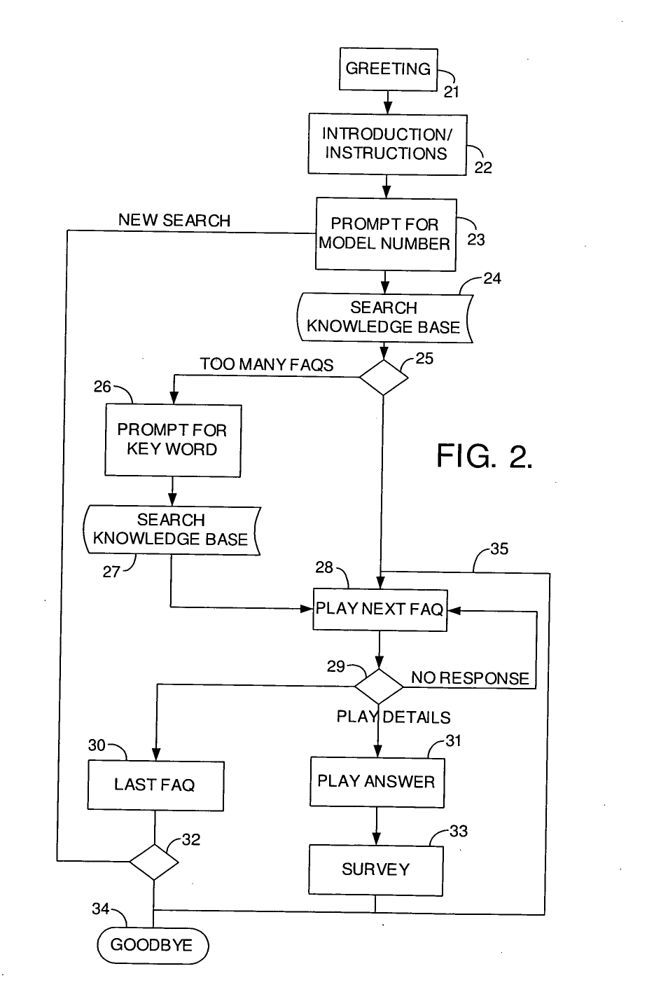

Referring now to FIG. 2, a high-level call flow diagram of the present invention is shown. Generally the process of the present invention begins upon the user's connection to the system, wherein the user shall hear a greeting 21 from the host followed by an introduction or instructions 22. At that point, the user is required to make his first audible selection based on the aforementioned instructions 22, in this example the user will receive a request to enter, e.g., the model number for the device for which he is interested in receiving information 23. After entering the model number the knowledge base is searched 24. The knowledge base is searched for a selection of frequently asked questions related to the user's response.

Once the frequently asked questions are retrieved, the system is faced with an internal decision 25. Generally, the system shall receive either too many frequently asked questions (FAQs), or a sufficient amount of frequently asked questions, based on the user's query. If there are deemed to be too many FAQs the user will again be prompted for a keyword 26. Once again the knowledge base is searched 27. And when a sufficient amount of FAQs are found they are delivered to the user 28 for play. However, if a sufficient amount of FAQs are found upon the initial search of the database 24, the FAQs are routed to the user 28 without need for further prompt.

As the FAQs are played for the user, the user is presented three options or decisions 29. If the particular FAQ presented to the user satisfies the user's query, he can choose to either hear details or hear an answer 31. Answers may be provided as pre-recorded audio announcements, text messages and/or voice XML applications or dialog. SSML tags and XML documents may be included. Additionally, if the user provides no response, the system will play the next FAQ 28. Finally, the user has the option of hearing the last FAQ played 30.

When the user chooses to play an answer, upon completion of the answer the user is prompted as to whether or not his question was answered. If the user is satisfied, he shall select/answer “yes”, and the end of call sequence 34 shall be initiated. If the user selects/answers “no”, he is transferred back 35 in the process to hear the next FAQ, wherein the aforementioned process shall be repeated. If the user chooses to play the last FAQ 30, he is queried 32 as to whether he wants to conduct a new search, wherein he will be prompted for a new model number 23, or terminate the phone call 34. If he decides to conduct a new search the process is repeated from the point where he provides, e.g., the new model number 23.

While a system above details a speech recognition system having VoiceXML gateway, the method of the present invention may be implemented in various systems wherein users may access the system via telephone, wireless phone, telephone with a display or device such as a PDA or a web browser. Upon accessing the system, the user interacts with the system to provide the keywords or otherwise information required by the system to perform a search in the knowledge database. Thus the invention can be implemented on other software platforms as one skilled in the art would appreciate.

Once the appropriate keywords are entered, the system searches the knowledge database wherein zero or more frequently asked questions pertaining to the search criteria provided by the customer are yielded. The resulting group of frequently asked questions are then presented to the user wherein the user selects one or more questions for details. Upon that selection, the system retrieves an answer object (whose form and function shall be defined by the invention) associated with the selected question. Additionally, the invention serves to examine the attributes of the answer thereby determining the appropriate processing mode. The attributes of the processing mode may include, but are not limited to; pre-recorded audio announcements, text only, text with SSML tags, XML document, VoiceXML application, VoiceXML subdialog; or a reference to a VoiceXML application or subdialog that is resident and maintained by the invention.

An additional feature of the present invention is the ability to process the answer object in the appropriate mode relative to the user's access device and channel. The mode chosen will be dependent upon the access channel, and the characteristics of the device associated with the access channel. In operation, when the answer objects are in the form of pre-recorded audio announcements, the answer object is played to the caller if a telephone is associated with the access channel, or sent to the access device using the appropriate communication protocol(s). When the answer object is in the form of a text document and the device utilizes a display supported by the access channel, text will be transmitted to the device using the appropriate display protocol and sent using the access channel and the appropriate communication protocol, such as HTML over HTTP via the Interact. When the device used to access the system is a telephone the text will be converted into audio using text-to-speech technology and played to the customer.

For instance, where the answer is text with SSML tags embedded in it and the device used to access the system comprises a display of known protocol, the text shall be rendered for the device using the correct display protocol and sent using the access channel and the associated communication protocol, such as HTML over HTTP via the Internet. Furthermore, the embedded mark-up will be ignored. As above, when the answer is text with SSML tags in it, but the device used to access the system is a telephone or has a telephone associated with it, the text is converted into audio using text-to-speech technology and played to the customer. The embedded SSML shall be used by the TTS engine to alter the rendered output appropriately.

Additionally, the answer object may be in the form of an XML document. For those instances the XML document will be rendered appropriately using invention specified transformation rules. In instances wherein the answer object is in the form of a VoiceXML application, the invention will extract the application and associated data, audio prompts, speech recognition grammars, etc., and create a package to be loaded into the application server. A URL will be constructed to reference the newly loaded application, and will be summoned by sending that URL to the VoiceXML gateway. The application will assume full control of the call, wherein answer object conventions are provided to add answer object collected information to the global call session as well as the means to inject events from a supported list to the call session state machine. Additionally, the invention supports a caching mechanism wherein target answer objects, currently resident and up to date, will not be reloaded.

When the answer object is in the form of a VoiceXML subdialog, the invention serves to extract the application and associated data, audio prompts, speech recognition grammars, etc., and creates a package to be loaded into the application server. A URL is constructed to reference the newly loaded subdialog, and a VoiceXML host document is constructed that references the subdialog. The host document is sent to the VoiceXML gateway where the subdialog will be invoked. Information collected by the subdialog is maintained for the duration of the call for use by other answer objects. As above, if the invention supports a caching mechanism wherein target answer objects, currently resident and is up to date, will not be reloaded.

It is an additional feature of the present invention to maintain a library of pre-deployed applications, capable of being invoked by reference from the answer object. This is accomplished by permitting the answer object to supply data, such as audio prompts and speech recognition grammars, that override the data in the library associated with the application. Furthermore, data that is collected by answer objects can be defined by the enterprise specific answer objects and shared amongst them, creating an extension of domain specific dynamic data managed by the system. Any data associated with the domain specific configuration of the knowledge base shall also available to the answer object for reading or updating. The system serves to analyze all the information collected by answer objects, and uses this information to accumulate and share information about the caller. The result is a dynamic system, adaptable to better serve the user's needs.

While this invention has been described as having a particular embodiment, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of searching a knowledge data base comprising the steps of:
receiving a query from a user, wherein said query is in the form of a spoken word or phrase;
converting said spoken word or phrase into a format capable of searching a knowledge database;
searching said knowledge database for at least one answer object to said query; and
e. presenting said at least one answer object to said user wherein said at least one answer object is in audible form.

2. The method of searching a knowledge data base of claim 1 further comprising the steps of:
searching said knowledge database for one or more frequently asked questions in response to said query from said user;
presenting said at least one frequently asked questions to said user wherein said user chooses a selected frequently asked question;
searching said knowledge database for said answer object associated with said selected frequently asked question; and
presenting said answer object to said user.

3. The method of searching a knowledge data base of claim 1 wherein said answer object is presented to said user in the form of an audible response.

4. The method of searching a knowledge data base of claim 2 wherein said answer object is presented to said user in the form of audible response.

5. A method of searching an enterprise knowledge base comprising the steps of:
accessing a system via an access channel;
interacting with said system to furnish keywords to search said enterprise knowledge base;
searching said knowledge database and retrieving a group of frequently asked questions, wherein said group of frequently asked questions comprises zero or more frequently asked questions, pertinent to said keywords;
presenting said group, of frequently asked questions to a user, wherein said user selects one or more of said frequently asked questions;
retrieving an answer object associated with said one or more frequently asked questions selected by the user; and
presenting said answer object to said user via said access channel.

6. The method of searching an enterprise knowledge base of claim 5 wherein said access channel is a telephone.

7. The method of searching an enterprise knowledge base of claim 5 wherein said access channel is a wireless telephone.

8. The method of searching an enterprise knowledge base of claim 5 wherein said access channel is a telephone with display.

9. The method of searching an enterprise knowledge base of claim 5 wherein said access channel is a PDA.

10. The method of searching an enterprise knowledge base of claim 5 wherein said access channel is a web browser.

11. The method of searching an enterprise knowledge base of claim 5 wherein said answer object is presented to said user as one or more pre-recorded audio announcements.

12. The method of searching an enterprise knowledge base of claim 5 wherein said answer object is presented to said user as a text message.

13. The method of searching an enterprise knowledge base of claim 5 wherein said answer object is presented to said user as text with SSML tags.

14. The method of searching an enterprise knowledge base of claim 5 wherein said answer object is presented to said user as an XML document.

15. The method of searching an enterprise knowledge base of claim 5 wherein said answer object is presented to said user as a VoiceXML application.

16. The method of searching an enterprise knowledge base of claim 5 wherein said answer object is presented to said user as VoiceXML subdialog.

17. The method of searching art enterprise knowledge base of claim 5 wherein said answer object is presented to said user as a reference to a VoiceXML application; wherein said VoiceXML application is maintained by said system.

18. The method of searching an enterprise knowledge base of claim 5 wherein said answer object is presented to said user as a reference to a VoiceXML subdialog, wherein said VoiceXML subdialog is maintained by said system.

19. An apparatus for searching an enterprise knowledge base comprising:
a means receiving a query from a user, wherein said query is in the form of a spoken word or phrase;
a means for converting said spoken word or phrase into a format capable of searching a knowledge database;
said knowledge database having a plurality of answer objects;
a means for searching said knowledge database for at least one answer object to said query; and
a means for presenting said at least one answer object to said user wherein said at least one answer object is in audible form.
